(19) United States
(12) Patent Application Publication
(10) Pub. No.: US 2026/0359558 A1
(43) Pub. Date: Nov. 12, 2026

(54) CONVERSION OF REFERENCE DOCUMENT TO PROMPT TEMPLATE

(71) Applicant: International Business Machines Corporation, Armonk, NY (US)

(72) Inventors: Sarbajit Kumar Rakshit, Kolkata (IN); Sathya Santhar, Ramapuram (IN); Sridevi Kannan, Katupakkam (IN)

(21) Appl. No.: 19/201,190

(22) Filed: May 7, 2025

(51) Int. Cl. G06F 40/186; G06F 40/284

(52) U.S. Cl. CPC G06F 40/186; G06F 40/284

(57) ABSTRACT

An exemplary system comprises a memory that stores and a processor that executes computer executable components stored in the memory, wherein the computer executable components comprise an identifying component that identifies a reference document corresponding to a specified context subject or a specified client entity, the reference document comprising first dynamic elements that define first context information, and a generating component that, based on the first dynamic elements, generates a prompt template corresponding to the specified context subject or the specified client entity and comprising second dynamic elements that define second context information different from the first context information. In one or more cases, the second dynamic elements comprise portions of the prompt template that are adjustable based on user entity input for the prompt template. In one or more cases, a finalizing component generates a resultant document based on the prompt template and on the user entity input.

### BACKGROUND

The subject disclosure relates generally to document generation and more particularly to generation of a prompt template based on a completed reference document, thereby aiding creation of a resultant document using the prompt template.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide for generally generating a resultant document based on a prompt template, and more particularly for identification of a relevant reference document, completed for a similar and/or same entity and/or having a similar and/or same contextual purpose as a desired prompt template, and generation of the prompt template based on the relevant reference document.

In accordance with an embodiment, a system can comprise a memory that stores and a processor that executes computer executable components stored in the memory, wherein the computer executable components comprise an identifying component that identifies a reference document corresponding to a specified context subject or a specified client entity, the reference document comprising first dynamic elements that define first context information, and a generating component that, based on the first dynamic elements, generates a prompt template corresponding to the specified context subject or the specified client entity and comprising second dynamic elements that define second context information different from the first context information.

In one or more cases, the second dynamic elements comprise portions of the prompt template that are adjustable based on user entity input for the prompt template.

In one or more cases, a finalizing component generates a resultant document based on the prompt template and on the user entity input.

In accordance with another embodiment, a computer-implemented method can comprise identifying, by a system operatively coupled to a processor, a reference document corresponding to a specified context subject or a specified client entity, the reference document comprising first dynamic elements that define first context information, and generating, by the system, based on the first dynamic elements, generates a prompt template corresponding to the specified context subject or the specified client entity and comprising second dynamic elements that define second context information different from the first context information.

In one or more cases, the second dynamic elements comprise portions of the prompt template that are adjustable based on user entity input for the prompt template.

In one or more cases, the method further comprises generating, by the system, a resultant document based on the prompt template and on the user entity input.

In accordance with still another embodiment, a computer program product facilitating a process to generate a resultant document based on a prompt template, can comprise a computer readable storage medium having program instructions embodied therewith, the program instructions executable by a processor to cause the processor to identify, by the processor, a reference document corresponding to a specified context subject or a specified client entity, the reference document comprising first dynamic elements that define first context information, and generate, by the processor, based on the first dynamic elements, generates a prompt template corresponding to the specified context subject or the specified client entity and comprising second dynamic elements that define second context information different from the first context information.

In one or more cases, the second dynamic elements comprise portions of the prompt template that are adjustable based on user entity input for the prompt template.

In one or more cases, the program instructions are further executable by the processor to cause the processor to generate, by the processor, a resultant document based on the prompt template and on the user entity input.

A benefit of the system, and/or of a corresponding computer-implemented method and/or computer program product, can be an ability to generate a prompt template using a dynamic process that is not limited to mere copy and paste from a reference document. Indeed a generated prompt template can minimize, expand upon, and/or maximize one or more dynamic elements and/or static elements of one or more reference documents, resulting in a new resultant document that differs from, and does not employ the exact structural skeleton of, the one or more reference documents.

Rather, using trained analytical models, a prompt template can be generated for a subject different from, similar to, or the same as one or more reference documents. Additionally and/or alternatively, using the trained analytical models, the prompt template can be generated for a client entity different from, similar to, or the same as one or more reference documents. In this way, the prompt template can be styled and suited to a more narrow and particular purpose (corresponding to a desired context subject and/or client entity) while remaining consistent with client entity style and/or contextual subject matter style (e.g., style used for a particular contextual subject matter) corresponding to the selected one or more reference documents.

As used herein, the term “style” can refer to any one or more of general syntax, word selection and/or diction, verb tense, sentence structure, format, structure, presentation order of information, voice selection (e.g., passive and/or active), tone and/or mood, grammar usage, etc.

Another benefit can be an ability generally to streamline content generation, maintain prompt template and reference document uniformity, enhance document professionalism, improve productivity, and/or reduce manual editing efforts. This can be at least partially due to processes performed by the one or more embodiments described herein for identifying static elements and dynamic elements of one or more selected reference documents.

As used herein, a static element can be an element of data/metadata that when employed at a prompt template does not adjust the prompt template to generate the resultant document in response to input data to the prompt template. Alternatively, a dynamic element can be an element of data/metadata that when employed at a prompt template causes modification of the prompt template to generate the resultant document in response to input data to the prompt template.

Still another benefit can be an ability to merge one or more writing styles from one or more reference documents into the prompt template and subsequent resultant document generated therefrom. For example, the one or more reference documents employed as writing style input to one or more analytical models can comprise the same one or more reference documents corresponding to a desired context subject and/or client entity and/or can be an alternative style reference document employed only for analysis of the writing style of that style reference document.

### DESCRIPTION OF THE DRAWINGS

FIG. 1 illustrates a block diagram of an example, non-limiting system that can provide a process to generate a prompt template and/or a resultant document from a prompt template, in accordance with one or more embodiments described herein.

FIG. 2 illustrates a block diagram of another example, non-limiting system that can provide a process to generate a prompt template and/or a resultant document from a prompt template, in accordance with one or more embodiments described herein.

FIG. 3 illustrates a block diagram of example inputs and outputs to the non-limiting system of FIG. 2, in accordance with one or more embodiments described herein.

FIG. 4 illustrates another block diagram of example inputs and outputs to the non-limiting system of FIG. 2, in accordance with one or more embodiments described herein.

FIG. 5 illustrates a schematic diagram of a long short-term memory transformer that can be employed by the non-limiting system of FIG. 2, in accordance with one or more embodiments described herein.

FIG. 6 illustrates a block diagram demonstrating use of a long short-term memory transformer by the non-limiting system of FIG. 2, in accordance with one or more embodiments described herein.

FIG. 7 illustrates another block diagram demonstrating use of a long short-term memory transformer by the non-limiting system of FIG. 2, in accordance with one or more embodiments described herein.

FIG. 8 illustrates a flow diagram of one or more processes that can be performed by the non-limiting system of FIG. 2, to generate a prompt template, in accordance with one or more embodiments described herein.

FIG. 9 illustrates another flow diagram of one or more processes that can be performed by the non-limiting system of FIG. 2, to generate a resultant document based on a prompt template, in accordance with one or more embodiments described herein.

FIG. 10 illustrates a continuation of the flow diagram of FIG. 9 of one or more processes that can be performed by the non-limiting system of FIG. 2, in accordance with one or more embodiments described herein.

FIG. 11 illustrates a block diagram of an example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In existing prompt template generation frameworks, a prompt template is generally generated from a reference document based on high-level section-based templates. As used herein, a prompt template is a document or other format comprising text and a set of one or more prompts to be responded to. Via user entity input corresponding to the prompts, a resultant document can generally be generated from the prompt template.

To generate the prompt template, a reference document can be employed as a base or a skeleton. Relative to a reference document, when the reference document has multiple sections and the contents are contributed by different entities, there can be a lack of standardized writing style leading to errors and misunderstandings, increasing time and resources spent on document creation and review. Existing frameworks fail to account for this aspect. Thus, uniformity and professionalism is not maintained between a reference document and a prompt template generated based thereon.

For example, if there is a need for an entity to create a request for proposal document, among an endless variety of other uses for prompt templates, such as for a client entity to propose deprecation of assets via modernization, then there may be multiple teams working on the document on different sections. In one or more cases, a standard corresponding template, in the exemplary case a request for proposal template, can be obtained and details filled in manual. Alternatively, a request for proposal can be generated manually from scratch.

In existing frameworks, there is no way to fetch a closest (e.g., similar) document which was completed for a similar client and/or a similar contextual purpose and then generate the desired document based on the closest document (e.g., the reference document).

Further, as noted above, inconsistent document quality and inefficiency in collaborative environments pose significant challenges. That is, existing frameworks fail to provide for merging of writing styles and/or maintaining of consistency in document preparation.

To account for one or more deficiencies of existing frameworks for generating a prompt template, the one or more embodiments described herein can generally, based on a reference document that corresponds to a similar and/or same client and/or a similar and/or same contextual purpose as desired for the prompt template that is to be generated, generate a prompt template. A resultant document can then be generated based on user input to one or more prompts of the prompt template, using the prompt template and the user inputs.

One or more embodiments described herein can perform these high level goals using various processes that can be divided into a non-limiting set of categories including, but not limited to, query input analysis, reference document identification and analysis, prompt template generation, retrieval-augmented generation of a resultant document, and/or post-processing corresponding to the resultant document.

As a result therefrom, a prompt template can be generated by the one or more embodiments described herein, where the prompt template has consistency with reference documents and where the prompt template is based on, but has prompts that differ from, the reference document. That is, the one or more embodiments described herein can employ one or more analytical models to generate a prompt template using a dynamic process that is not limited to mere copy and paste from a reference document. Indeed a generated prompt template can minimize, expand upon, and/or maximize one or more dynamic elements and/or static elements of one or more reference documents, resulting in a new resultant document that differs from, and does not employ the exact structural skeleton of, the one or more reference documents.

As used herein, the term “analytical model” can refer to any suitable model that employs artificial intelligence and/or machine learning, such as an artificial intelligence (AI) model, machine learning (ML) model, neural network (NN) model, convoluted neural network (CNN) model, etc., without being limited thereto.

As used herein, the term “data” can comprise metadata.

As used herein, the terms “entity,” “client entity,” “requesting entity,” and “user entity” can refer to a machine, device, component, hardware, software, smart device, party, organization, individual and/or human.

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

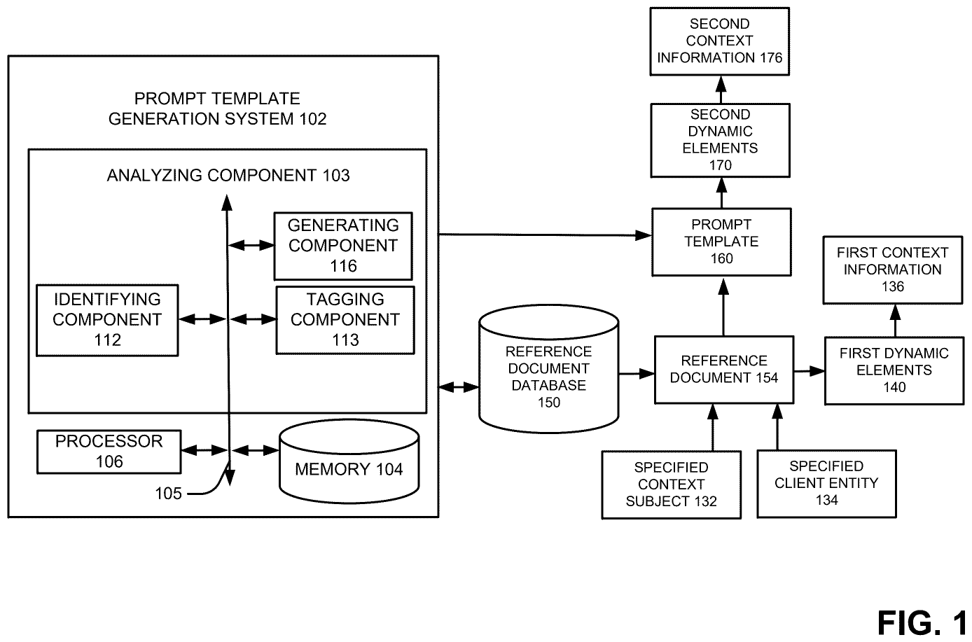

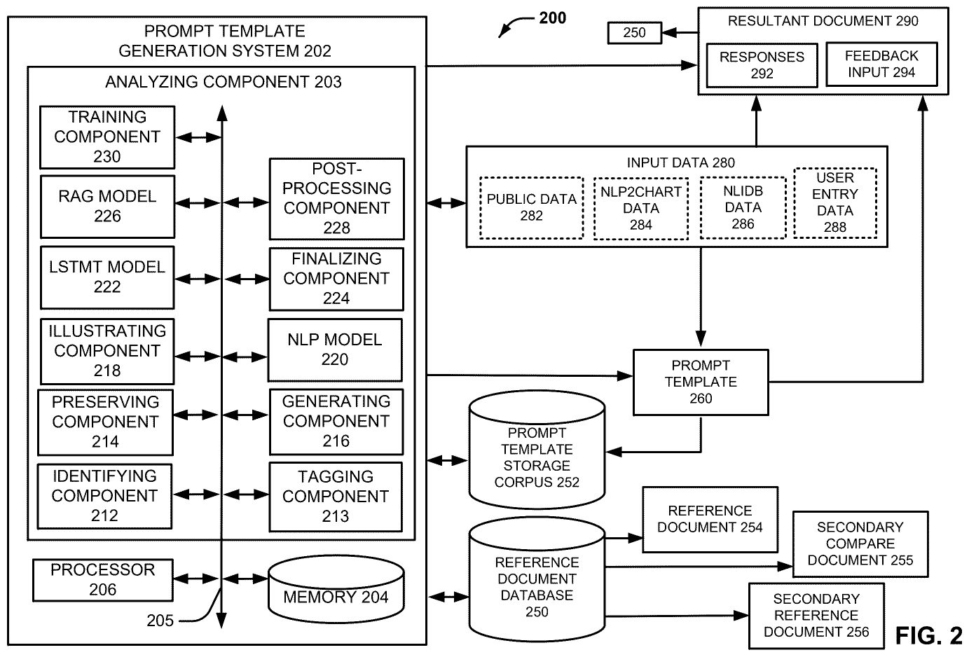

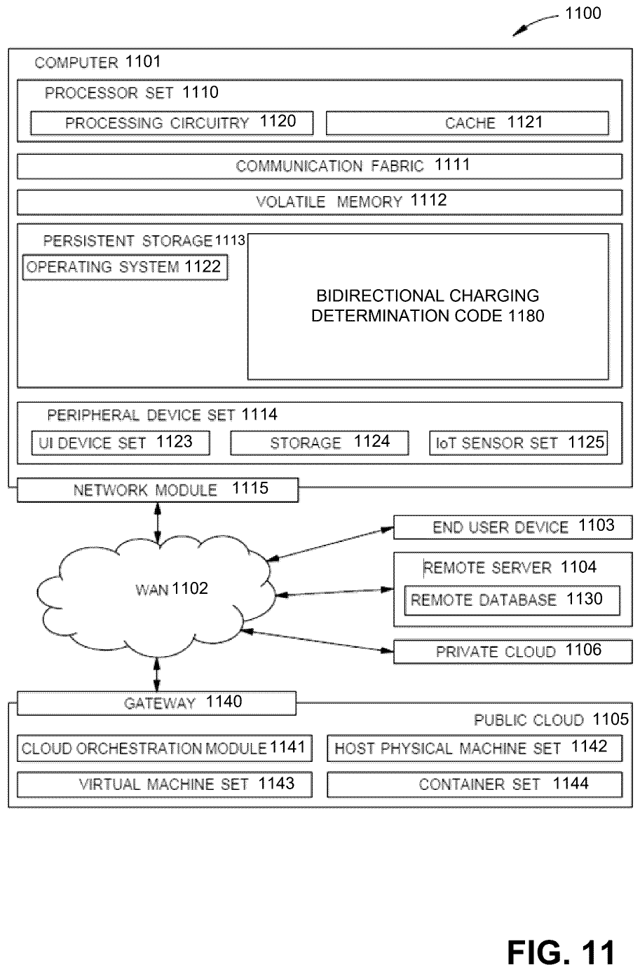

For example, in one or more embodiments, the non-limiting system 100 (FIG. 1) or the non-limiting system 200 (FIG. 2) can further comprise one or more computer and/or computing-based elements described herein with reference to a computing environment, such as the computing environment 1100 illustrated at FIG. 11. In one or more described embodiments, computer and/or computing-based elements can be used in connection with implementing one or more of the systems, devices, components and/or computer-implemented operations shown and/or described in connection with FIG. 1, FIG. 2 and/or with one or more other figures described herein.

Turning now in particular to one or more figures, and first to FIG. 1, the figure illustrates a block diagram of an example, non-limiting system 100 that can facilitate generation of a prompt template in a dynamic manner that employs, but is not limited by, one or more selected/specified reference documents.

That is, the non-limiting system 100 can comprise a prompt template generation system 102. It is noted that the prompt template generation system 102 is described only briefly, relative to FIG. 1, to provide but a lead-in to description of a more complex and/or more expansive prompt template generation system 202 as illustrated at FIG. 2. That is, further detail regarding processes that can be performed by one or more embodiments described herein will be provided below relative to the non-limiting system 200 of FIG. 2.

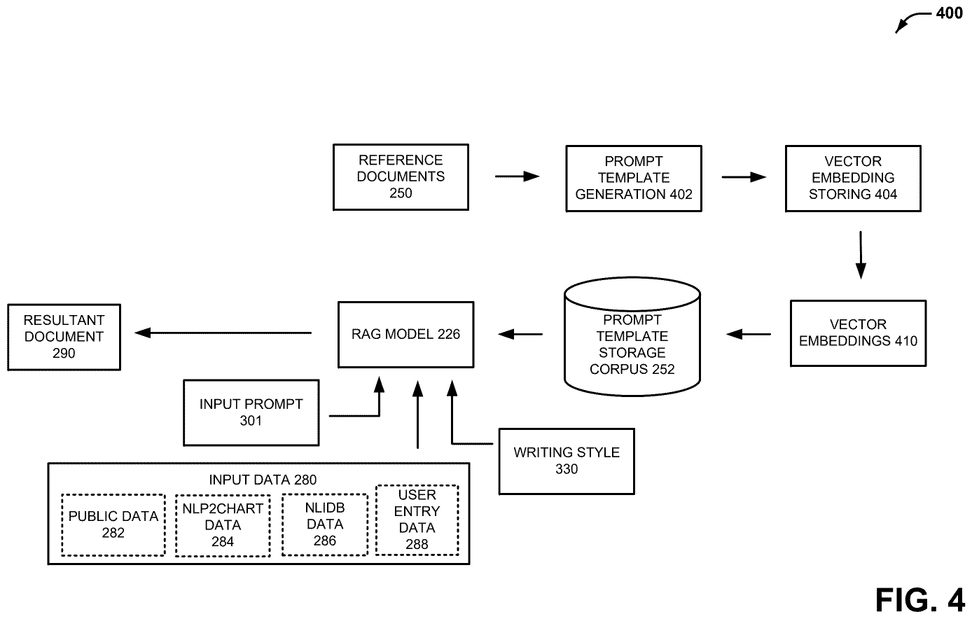

Still referring to FIG. 1, and also again to FIG. 4, the prompt template generation system 102 can comprise at least a memory 104, bus 105, processor 106, identifying component 112, tagging component 113 and/or generating component 116. Using these components, the prompt template generation system 102 can provide for generation of a prompt template 160.

Generally, the identifying component 112 can identify a reference document 154 corresponding to a specified context subject 132 or a specified client entity 134, the reference document 154 comprising first dynamic elements 140 that define first context information 136.

The generating component 116 can, based on the first dynamic elements 140, generate the prompt template 160 corresponding to the specified context subject 132 or the specified client entity 134 and comprising second dynamic elements 170 that define second context information 176 different from the first context information 136.

In one or more embodiments, the identifying component 112, tagging component 113 and/or generating component 116 can be implemented independently, without other of the identifying component 112, tagging component 113 and/or generating component 116. Additionally and/or alternatively, the identifying component 112, tagging component 113 and/or generating component 116 can be comprised by a high-level analyzing component 103, the high-level analyzing component 103 can perform one or more of the above-described functions of the identifying component 112, tagging component 113 and/or generating component 116, and/or the identifying component 112, tagging component 113 and/or generating component 116 can be omitted with the high-level analyzing component 103 performing one or more of the above-described functions of the omitted identifying component 112, tagging component 113 and/or generating component 116.

In general, the non-limiting system 100 can employ any suitable method of communication (e.g., electronic, communicative, internet, infrared, fiber, etc.) to provide communication between the classical system 102 and one or more databases, such as a reference document database 150.

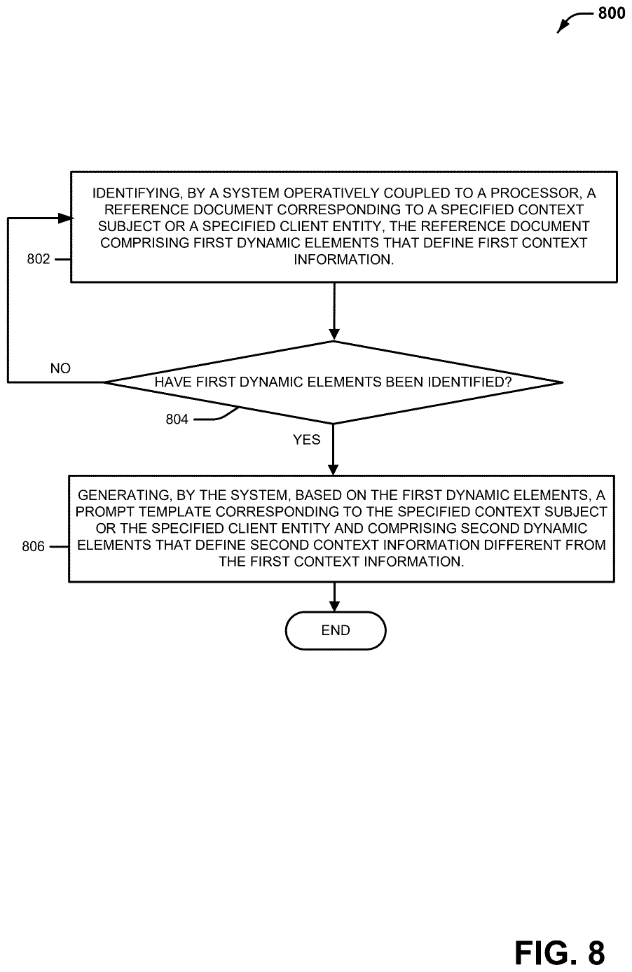

As a summary, referring next briefly to FIG. 8, illustrated is a flow diagram of an example, non-limiting method 800 that can provide a process to generate a prompt template 160, in accordance with one or more embodiments described herein, such as the non-limiting system 100 of FIG. 1. Repetitive description of like elements and/or processes employed in respective embodiments is omitted for sake of brevity.

At 802, the non-limiting method 800 can comprise identifying, by a system operatively coupled to a processor (e.g., identifying component 112 coupled to processor 106), a reference document (e.g., reference document 154) corresponding to a specified context subject (e.g., specified context subject 132) or a specified client entity (e.g., specified client entity 134), the reference document comprising first dynamic elements (e.g., first dynamic elements 140) that define first context information (e.g., first context information 136).

At 804, the non-limiting method 800 can comprise determining, by the system (e.g., tagging component 113), whether first dynamic elements have been identified. If yes, the non-limiting method 800 can proceed to step 806. If not, the non-limiting method 800 can proceed back to step 802.

At 806, the non-limiting method 800 can comprise, based on the first dynamic elements, generating, by the system (e.g., generating component 116) a prompt template (e.g., prompt template 160) corresponding to the specified context subject or the specified client entity and comprising second dynamic elements (e.g., second dynamic element 170) that define second context information (e.g., second context information 176) different from the first context information.

Turning next to FIG. 2, a non-limiting system 200 is illustrated that can comprise a prompt template generation system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the non-limiting system 200 can facilitate a process to generate a prompt template 260 from one or more reference documents 254 and/or to generate a resultant document 290 from one or more prompt templates 260.

The non-limiting system 200 can comprise a prompt template generation system 202 that can provide for the prompt template generation and/or resultant document generation. The non-limiting system 200 can additionally comprise one or more databases, such as a prompt template storage corpus 252 and/or reference document database 250. It is noted that one or more of such databases can be disposed externally to the non-limiting system 200, but communicatively accessible to the prompt template generation system 202, in one or more embodiments.

Turning now in particular to the non-limiting system 200 of FIG. 2, one or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The prompt template generation system 202 can be associated with, such as accessible via, a cloud computing environment.

The prompt template generation system 202 can comprise a plurality of components. The components can comprise a memory 204, processor 206, bus 205, identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230. Using these components, the non-limiting system 200 generally can generate perform various processes related to input prompt analysis, reference document identification, static and dynamic entity identification, prompt template generation, prompt response execution, analytical model training, feedback analysis, and/or resultant document generation.

Discussion first turns briefly to the processor 206, memory 204 and bus 205 of the prompt template generation system 202. For example, in one or more embodiments, the prompt template generation system 202 can comprise the processor 206 (e.g., computer processing unit, microprocessor, classical processor, quantum processor and/or like processor). In one or more embodiments, a component associated with prompt template generation system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230.

In one or more embodiments, the prompt template generation system 202 can comprise the computer-readable memory 204 that can be operably connected to the processor 206. The memory 204 can store computer-executable instructions that, upon execution by the processor 206, can cause the processor 206 and/or one or more other components of the prompt template generation system 202 (e.g., identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230) to perform one or more actions. In one or more embodiments, the memory 204 can store computer-executable components (e.g., identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230).

The prompt template generation system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the prompt template generation system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the prompt template generation system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the prompt template generation system 202 and any one or more databases.

In addition to the processor 206 and/or memory 204 described above, the prompt template generation system 202 can comprise one or more computer and/or machine readable, writable and/or executable components and/or instructions that, when executed by processor 206, can provide performance of one or more operations defined by such component and/or instruction.

Discussion next turns to the additional components of the prompt template generation system 202 (e.g., identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230).

First, it is noted that in one or more embodiments, the identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230 can be implemented independently, without one or more other of the identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230. Additionally and/or alternatively, the identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230 can be comprised by a high-level analyzing component 203, one or more of the below-described functions of the identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230 can be performed by the high-level analyzing component 203, and/or the identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230 can be omitted. In the latter omission case, the high-level analyzing component 203 can instead perform one or more of the below-described functions of the one or more omitted identifying component 212, tagging component 213, preserving component 214, generating component 216, illustrating component 218, natural language processing (NLP) model 220, long short-term memory transformer (LSTMT) model 222, finalizing component 224, retrieval-augmented generation (RAG) model 226, post-processing component 228, and/or training component 230.

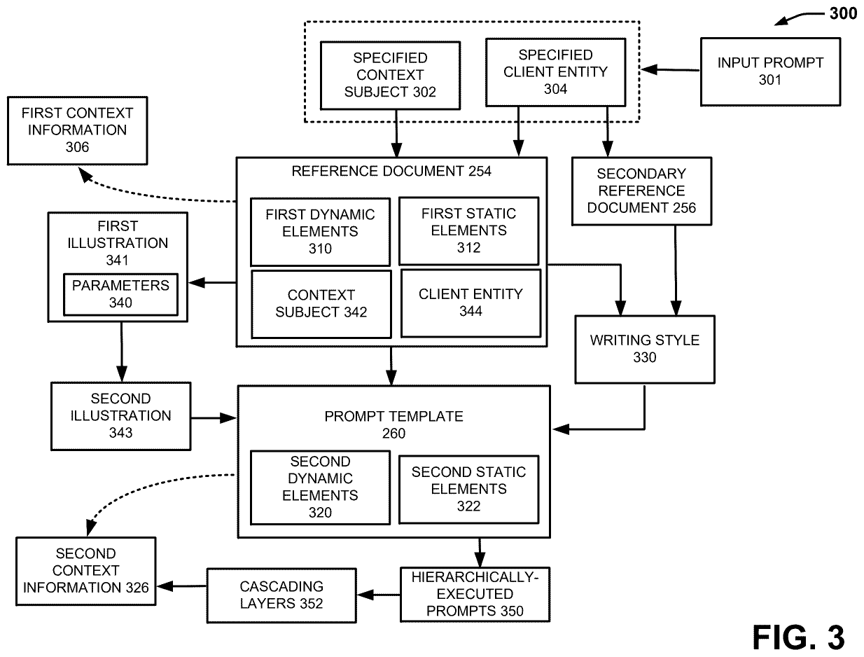

Direction now turns to FIG. 3, in addition to FIG. 2, and to a first set of processes for query input analysis and reference document identification.

First, the identifying component 212 can identify an input prompt 301 that defines a request to generate a prompt template 260. The input prompt 301 can comprise any suitable data and/or metadata. The input prompt 301 can comprise a query, request, reference document 254, and/or other input. For example, the input prompt 301 can comprise a hypothesis expressed as a question and/or a corpus. For another example, the input prompt 301 can comprise receipt of a reference document 254 expressed as complex information. As used herein, complex information can refer to a collection of different section in one or more reference documents 254, where each section can comprise any one or more figures, texts, pictures, tables, etc.

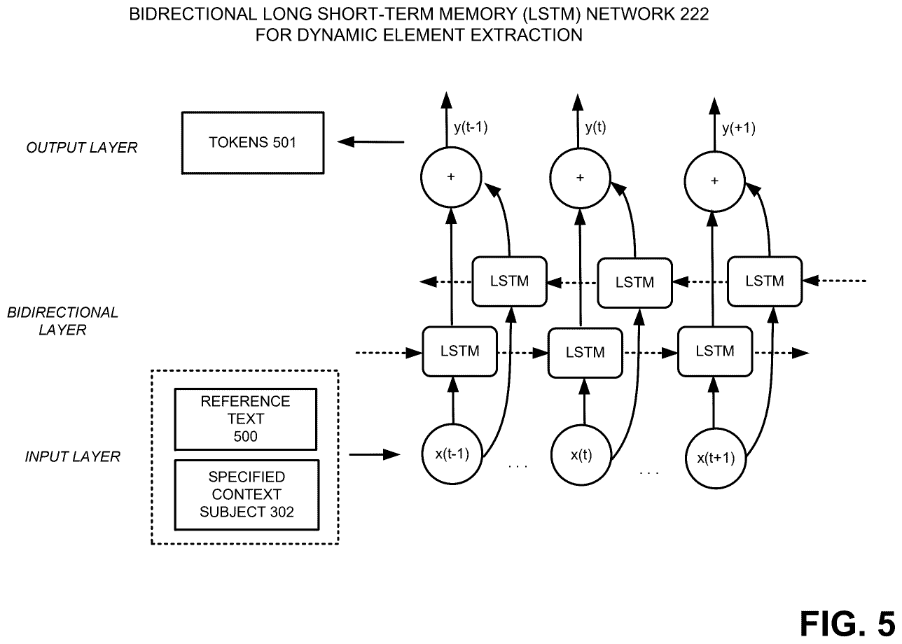

That is, based on an input prompt 301 to the prompt template generation system 202, the identifying component 212 can identify at least one reference document 254 with which to generate a prompt template 260. This identifying can comprise obtaining, searching, querying, determining, receiving, sending, etc. at any suitable database internal and/or external to the prompt template generation system 202 and/or non-limiting system 200. Further, the reference document 254 can be in any suitable language and/or format, comprise data and/or metadata, and be a public and/or private document. As used herein, a public document can be one for which the public has access, while a private document can be one for which the client entity or a select/specified group of entities have access. Moreover, a reference document can comprise any one or more of text 500 (FIG. 5), figures, tables, illustrations 341, charts, graphs, etc., without being limited thereto.

In one or more cases, a reference document 254 can be obtained from the reference document database 250. It is noted that any suitable number of reference documents 254 can be employed to generate the prompt template 260, allowing for more than mere 1-to-1 generation of the prompt template 260.

Based on the input prompt 301, the identifying component 212 can determine whether to employ a reference document 254 having a same and/or similar specified context subject 342 and/or same and/or similar client entity 344 as compared to a specified context subject 302 and/or specified client entity 304 determined based on the input prompt 301. A context subject can refer to a contextual purpose, definition, abstract, general description, subject matter, etc. to generally define a reference document 254. Any reference document 254 can have a context subject 342 that is same and/or similar to a specified context subject 302 based on the input prompt 301. Additionally, and/or alternatively, any reference document 254 can have a client entity that is same and/or similar to a specified client entity 304 based on the input prompt 301. A client entity can be an author entity and/or entity for which the reference document 254 pertains, refers to, and/or is about.

For example, a reference document 254 can be identified based on its data and/or metadata defining a contextual purpose. In one or more cases, a reference document 254 can be identified based on contextual comparison among two or more reference documents 254.

Once a reference document 254 has been identified, the tagging component 213 and one or more analytical models can analyze the reference document 254. This analyzing can comprise generally parsing the reference document 254 and tagging one or more first static elements 312 and/or one or more first dynamic elements 310 of the reference document 254.

Relative to a reference document 254, a static element 312 can be an element of data/metadata that when employed at a prompt template 260 does not adjust the prompt template 260 in response to input data 280 to the prompt template 260. Alternatively, a dynamic element 310 can be an element of data/metadata that when employed at a prompt template 260 causes modification of the prompt template 260 to generate a resultant document 290 in response to input data 280 to the prompt template 260.

Put another way, whether the reference document 254 is obtained by the identifying component 112 in response to and/or as part of the input prompt 301, the analyzing of a reference document 254 by the identifying component 212 can comprise generally breaking down the reference document 254 into isolated portions throughout the reference document 254.

The first static elements 312 and first dynamic elements 310 can together define first context information 306 of the reference document 254. That is, the first context information 306 comprises information that corresponds to and/or expands upon the context subject of the reference document 254. The first context information 306 can comprise data and/or metadata, and/or can be in the form of text, illustrations, graphs, charts, etc., without being limited thereto.

More particularly, the identifying component 212 can employ the tagging component 213 to identify and tag the one or more first static elements 312 and/or the one or more first dynamic elements 310 of each portion using one or more analytical models. These analytical models can comprise any suitable AI model, ML model, NN model, CNN model, etc. For example, these analytical models can comprise, but are not limited to, a natural language processing (NLP) model 220 and/or a long short-term memory transformer (LSTMT) model 222.

For example, the identifying component 212, such as by way of the tagging component 213, can employ the natural language processing model 220 to identify the first dynamic elements 310 and first static elements 312 by employing original text of the reference document 254 as input and the first context information as conditions for the natural language processing model 220.

In one or more cases, an NLP model 220, such as a named entity recognition (NER) model, can be trained, such as by the training component 230, based on determination of static entities and dynamic entities of an input tagged dataset. That is, the NLP model 220 can be finetuned, such as by the training component 230, with a labeled dataset that is labeled based on such entities to identify the static and dynamic entities of a set of text with input as the original text (e.g., reference text 500) and specified context subject 302 as the context.

In one or more embodiments, a pre-trained conditional language NER model can be finetuned with labeled dataset to identify static and dynamic elements in reference documents 254. For example, a training dataset can comprise text information with manual tagging of static and dynamic elements, where the NER model is to correctly identify the static and dynamic portions which will be compared against manual tagging. If there is error in the prediction, then the NER model can be directed to perform, or can automatically perform, various iterations, minimizing errors in each subsequent iteration. Once the errors reach a specified threshold, such as not reducing further, next text can be obtained from the training data set for evaluation with the same process. When the NER model analyzes many, such as thousands, of such manually tagged datasets, it can become finetuned to identify the static and dynamic portions of a new, and non-manually tagged, reference document 254.

For another example, turning to FIG. 5, the identifying component 212, such as by way of the tagging component 213, can employ the long short-term memory transformer model 222 to identify the first dynamic elements 310 and first static elements 312 by extracting tokens 501 from the reference document 254. An example schematic of such model 222 is illustrated at FIG. 5. In the model 222 illustrated at FIG. 5, x is the series of words in the input text in vector form, y is the series of words in the output text in vector form, and + refers to correlating the information both from current words in the text to the previous words in the text. For example, if there is a line stating “the company is doing well. It has three branches in India,” the term “it” can be correlated to “company” in the previous sentence. This is performed by the “+” layer.

The tokens extracted 501 can be, comprise and/or correspond to first dynamic elements 310. In one or more cases, aspects of text between the tokens extracted 501 can correspond to, comprise and/or be first static elements 312. one or more cases, the tokens 501 can define contextual and/or semantic differences between the reference document 254 and a secondary compare document 255. The secondary compare document 255 can be in any suitable language and/or format, comprise data and/or metadata, and be a public and/or private document.

In one or more cases, an LSTMT model 222 can be trained, such as by the training component 230, based on determination of static entities and dynamic entities of an input tagged dataset. That is, the LSTMT model 222 can employ transformer-based text pair encoding models that can be finetuned, such as by the training component 230, with one or more such datasets to take two or more reference texts 500 (e.g., of a reference document 254 and/or secondary compare document 255) as inputs along with the specified context subject 302 as the condition.

Tokens 501 can be extracted that are different token-by-token and/or that differ semantically. For example, if there are two reference documents 254, with one comprising company 3^{rd} quarter results and another comprising company 4^{th} quarter results, then the LSTMT model 222 can compare the reference documents 254 to identify portions of the corresponding texts that are changing/different between the two reference documents 254. The text changing and/or differences correlate to dynamic elements 310, while non-different portions can correlate to static elements 312. Each word in each reference document 254 can be referred to as a token. In one or more other cases, groups of two or more words can be referred to as a token. That is, the comparison performed by the LSTMT model 222 between the two reference documents 254 can be performed token-by-token or by semantic comparison. Semantic comparison can be employed because text lines between the two reference documents 254 can be written differently but have same meaning. In such case, these portions written different but having same meaning can be considered as static elements 312 instead of dynamic elements 310.

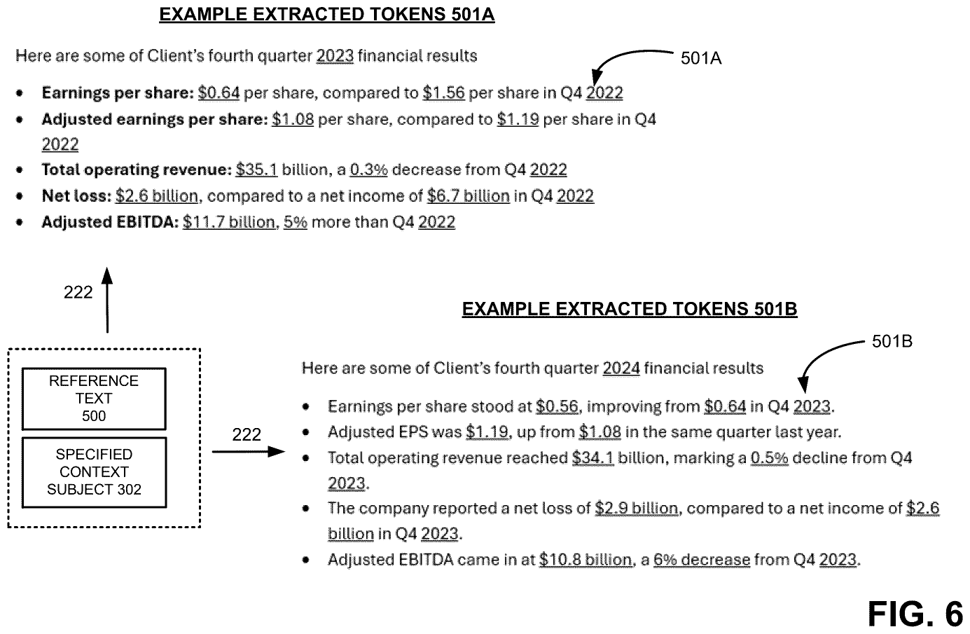

Referring briefly to FIG. 6, illustrated is an example result of use of the LSTMT model 222 for extracting tokens 501A and 501B from reference text 500 of a pair of reference documents 524. At FIG. 6, the tokens to be extracted are underlined. It is noted that tokens 501 for either reference document 524 can be extracted on a token-by-token basis without regard to the other of the reference documents 524. Additionally, and/or alternatively, tokens 501 for one or both reference documents 524 can be extracted based on comparing the pair of reference documents 524, such as for semantic differences.

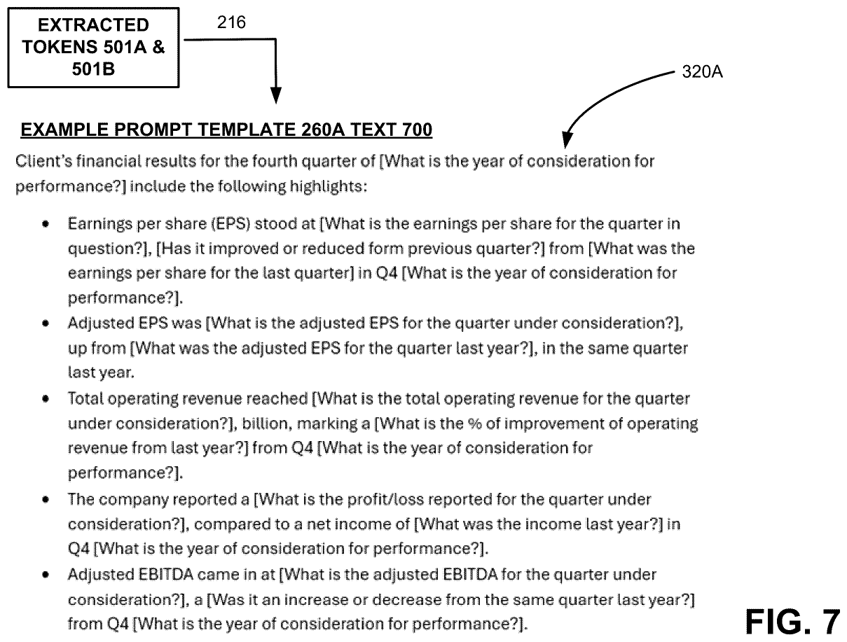

Turning to FIG. 7, the extracted tokens 501A and 501B (FIG. 6) can be employed, such as by the generating component 216, to generate example text 700 for an example prompt template 260A. As illustrated at FIGS. 6 and 7, the information comprised by the extracted tokens 501A and 501B can be employed to generate a set of second dynamic elements 320A (shown in brackets at FIG. 7) comprising prompts (e.g., inquiries, questions, etc.) that can be evaluated and answered, such as by the retrieval-augmented generation model 226 and the finalizing component 224 to generate the resultant document 290. It is noted that the second dynamic elements 320A define second context information 326 that is different from, but related to, first context information 306 corresponding to the example reference text 500 for the pair of reference documents illustrated at FIG. 6.

It is noted that an NLP model 220 and/or an LSTMT model 222 can be employed by the tagging component 213, and thus by the identifying component 212, relative to one or more same and/or different reference documents 254 for a same input prompt 301. Any one or more processes performed by an NLP model 220 and/or an LSTMT model 222 can be employed at least partially in parallel with one another.

In one or more embodiments, a writing style 330 can be identified by the preserving component 214 in connection with the identifying component 212. That is, the preserving component 214, based on the input prompt 301 or another input prompt 301, can identify the reference document 254 or a secondary reference document 256 as being directed to a writing style 330 to be employed (e.g., by the generating component 216) for generating the prompt template 260. In one or more cases two or more writing styles 330 can be identified and/or two or more secondary reference documents 2656 can be identified, allowing for merging of two or more writing styles 330 into a single prompt template 260.

The secondary reference document 256 can be in any suitable language and/or format, comprise data and/or metadata, and be a public and/or private document.

By identifying one or more writing styles 330, consistency of presentation, voice, tone, cadence, etc. can be preserved between prompt templates 260 and/or reference documents 256. This can improve professionalism and/or reduce manual editing efforts corresponding to a prompt template 260 and/or resultant document 290 to be generated, which processes existing frameworks for document generation cannot provide.

Direction now turns to FIG. 4, while still referring to FIGS. 2 and 3, with FIG. 4 illustrating the workflow 400 of processes that can be performed by the prompt template generation system 202 to generate the resultant document 290 based on the prompt template 260.

The prompt template generation 402 by the generating component 216 can comprise generating one or more second static elements 322 and one or more second dynamic elements 320 based on the analysis performed by the identifying component 212 and tagging component 213.

For example, the first static elements 312 can be employed to generate second static elements 332 serving as a backbone and/or skeleton of the prompt template 260. The second static elements 332 can be different from, and need not be duplicates of, the first static elements 312.

In one or more embodiments, a prompt template can be generated, by the generating component 216, by generating a set of prompts (e.g., inquiries, queries, text boxes, fill-ins, etc.) relative to one or more, such as each, dynamic portion of a specified reference document 254. Each prompt set can be a single prompt or hierarchical prompts where an answer for one prompt can be employed to generate a next prompt in the associated hierarchy. The generating component 216 and/or finalizing component 224 can obtain answers to the prompts from any one or more different sources of input data 280, to be described below.

Relative to hierarchical prompts, the first dynamic elements 310 can be employed by the generating component 216 to generate the second dynamic elements 320. The second dynamic elements 320 can comprise a set of hierarchically-executable prompts 350 that when executed (e.g., as hierarchically-executed prompts 350) can define cascading layers 352 of information defining second context information 326 of the prompt template 260. The second context information 326 can comprise data and/or metadata, and/or can be in the form of text, illustrations, graphs, charts, etc., without being limited thereto.

For example, a first prompt based on one second dynamic element 320 can lead to a second prompt based on another second dynamic element 320. In one or more cases, the second prompt can leverage and/or employ information from a modified and/or responded prompt to fully define the second prompt. The second prompt can have one or more different versions which can be comprised by the prompt template 260, thus allowing for the cascading layers 352 of information, similar to an information tree that splits into two or more information branches from an initial information stem.

For example, this can be accomplished, by the generating component 216, by generating a new prompt to get an answer for a dynamic element 310 of a reference document 254. In one case, the reference document 254 can comprise a line “The company reported net loss of X million dollars” where “X million dollars” is the dynamic element 310 identified. A new prompt can be generated by the generating component 216, such as to the model 222 or model 220, to generate a prompt question such that the response should be “The company reported net loss of X million dollars” with “X million dollars” as the unknown part in the question. The model 222 or model 220 would respond “What was the net loss reported by the company?” which would become a dynamic element 320 of the prompt template 260.

As noted above, the second context information 326 can be different from the first context information 306 of the one or more reference documents 254 employed to generate the prompt template 260. For example, while the first context information 306 and second context information 326 can each correspond to a specified context subject 302 (e.g., both are financial information, without being limited thereto), the second context information 326 can be directed to a different sub-set of the specified context subject 302 than the first context information 306.

Put another way, the prompt template 260 can be generated using a dynamic process that is not limited to mere copy and paste from a reference document 254. Indeed a generated prompt template 260 can minimize, expand upon, and/or maximize one or more dynamic elements 310 and/or static elements 312 of one or more reference documents 254, resulting in prompt template 260 that differs from, and does not employ the exact structural skeleton of, the one or more reference documents 254.

Rather, using trained analytical models (e.g., NLP model 220 and/or LSTMT model 222), a prompt template 260 can be generated for a subject different from, similar to, or the same as one or more reference documents 254. Additionally and/or alternatively, using the trained analytical models, the prompt template 260 can be generated for a client entity different from, similar to, or the same as one or more reference documents 254. In this way, the prompt template 260 can be styled and suited to a different, more narrow, or more broad purpose (corresponding to a desired context subject and/or client entity) while remaining consistent with client entity style and/or contextual subject matter style (e.g., style used for a particular contextual subject matter) corresponding to the selected one or more reference documents 254.

In one or more cases, the prompt template 260 can be stored as a set of one or more vector embeddings 410, such as at a prompt template storage corpus 252 that is communicatively accessible to the prompt template generation system 202. For example, the generating component 216 can translate a prompt template 260 into vector embeddings 410 via a suitable vector embedding storing process 404. A vector embedding 410 can have a formula of

$$P = \{ {p}_{i}^{t} \}$$

where P is a set of prompts, p is a standalone type of derived prompts from a set of the prompts P, and i is the section index. The reference t can define the elements of the section i. For example, i=1 may correlate to a first section of company's performance. Then, t₁ would correlate to text describing company's performance, t₂ could comprise a chart in that section, and t₃ could comprise a table in that section.

Discussion next turns to the generation of the resultant document 290 by the finalizing component 224. As illustrated at FIG. 4, using the prompt template 260, the input prompt 301, the writing style 330 and input data 280, the finalizing component 224, employing a retrieval-augmented generation (RAG) model 226 can generate the resultant document 290. The resultant document 290 can comprise one or more responses 292 to one or more prompts of the prompt template 260 (e.g., the prompts based on the second dynamic elements 320).

In one or more cases, more than one prompt template 260 can be employed by the finalizing component 224 to generate a more comprehensive and/or extensive resultant document 290.

The RAG model 226, and thus the finalizing component 224 can employ various inputs (e.g., input data 280) to respond to the prompts (e.g., to modify the second dynamic elements 320) of the prompt template 260 to thereby generate the text of the resultant document 290. The input data 280 can comprise, but is not limited to public data 282 (as defined above), natural language-part 2 chart (NLP2CHART) data 284, natural language interfaces for databases (NLIDB) data 286 and/or user entry data 288. User entry data 288 can be entered using any suitable computing device communicatively accessible by and/or to the non-limiting system 200. The input data 280 can be employed to automatically modify one or more second dynamic elements 320, such as by responding to one or more prompts of the prompt template 260 that are defined and/or comprised by the second dynamic elements 320.

In one or more cases, the finalizing component 224 can be aided by the illustrating component 218. For example, the illustrating component can, based on parameters 340 (FIG. 3) defining a first illustration 341 of a selected reference document 254, generate a second illustration 343 to be employed for the prompt template 260 and/or for a resultant document 290. The second illustration 343 can define the second context information 326, at least partially, and can employ the parameters 340 in its generation.

In one or more cases, a post-processing component 228 can obtain user entity feedback input 294 which can be provided by any suitable method of communication of a user entity computing device with the non-limiting system 200 and/or prompt template generation system 202. The user entity feedback input 294 can comprise direct manual edits to the resultant document 290 and/or one or more additional input prompts defining one or more requests for the RAG model 226 to modify the resultant document 290. It is further noted that these processes performed by the post-processing component 228 can likewise be performed relative to the prompt template 260 and need not only be performed on the resultant document 290 generated based on the prompt template 260.

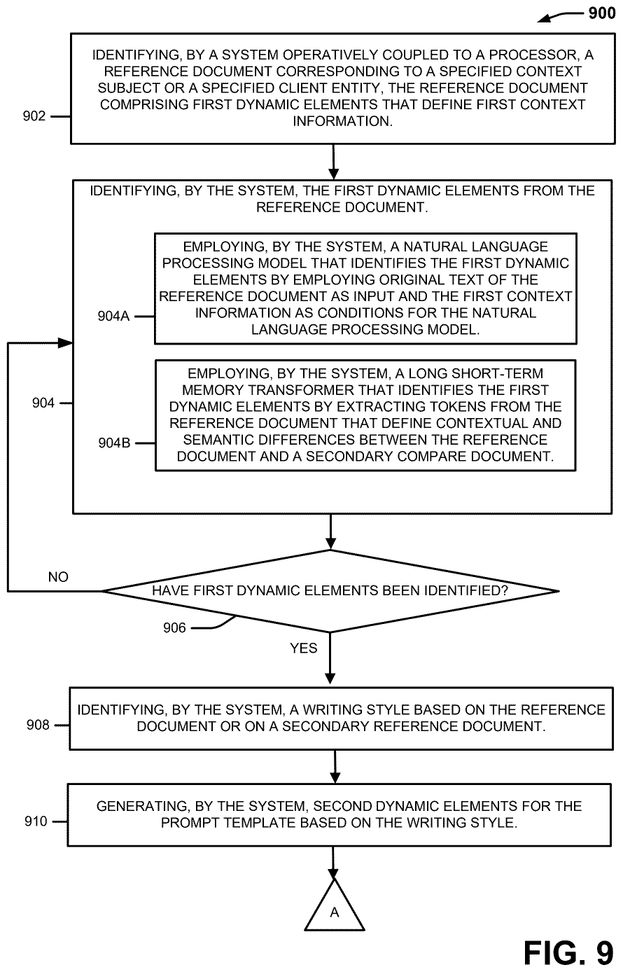

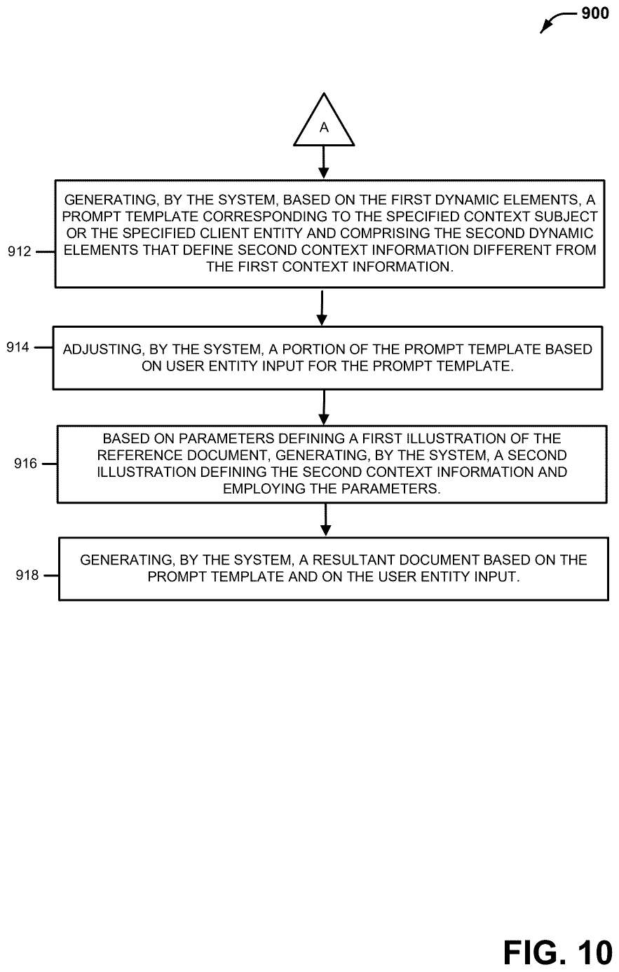

Referring next to FIGS. 9 and 10, as a summary of the above-described processes that can be performed by the non-limiting system 200, illustrated is a flow diagram of an example, non-limiting method 900 that can provide a process to generate a prompt template and resultant document, in accordance with one or more embodiments described herein, such as the non-limiting system 200 of FIG. 2. While the non-limiting method 900 is described relative to the non-limiting system 200 of FIG. 2, the non-limiting method 900 can be applicable also to other systems described herein, such as the non-limiting system 100 of FIG. 1. Repetitive description of like elements and/or processes employed in respective embodiments is omitted for sake of brevity.

At 902, the non-limiting method 900 can comprise identifying, by a system operatively coupled to a processor (e.g., identifying component 212 coupled to processor 206), a reference document (e.g., reference document 254) corresponding to a specified context subject (e.g., specified context subject 302) or a specified client entity (e.g., specified client entity 304), the reference document comprising first dynamic elements (e.g., first dynamic elements 310) that define first context information (e.g., first context information 306).

At 904, the non-limiting method 900 can comprise identifying, by the system (e.g., tagging component 213), the first dynamic elements from the reference document.

In one or more embodiments, step 904 can comprise step 904A of the non-limiting method 900, which can comprise employing, by the system (e.g., tagging component 213), a natural language processing model (e.g., NLP model 220) that identifies the first dynamic elements by employing original text (e.g., text 500) of the reference document as input and the first context information as conditions for the natural language processing model.

In one or more embodiments, step 904 can comprise step 904B of the non-limiting method 900, which can comprise employing, by the system (tagging component 213), employs a long short-term memory transformer (e.g., LSTMT model 222) that identifies the first dynamic elements by extracting tokens (e.g., tokens 501) from the reference document that define contextual and semantic differences between the reference document and a secondary compare document (e.g., secondary compare document 255).

Step 904 can comprise step 904A and/or step 904B. Steps 904A and 904B can be performed at least partially in parallel with one another relative to a same reference document.

At 906, the non-limiting method 900 can comprise determining, by the system (e.g., tagging component 213), whether the first dynamic elements have been identified. If yes, the non-limiting method 900 can proceed to step 908. If not, the non-limiting method 900 can proceed back to step 904.

At 908, the non-limiting method 900 can comprise identifying, by the system (e.g., preserving component 214), a writing style (e.g., writing style 330) based on the reference document or on a secondary reference document (e.g., secondary reference document 256).

At 910, the non-limiting method 900 can comprise generating, by the system (e.g., generating component 216) second dynamic elements (e.g., second dynamic elements 320) based on the writing style.

At 912, the non-limiting method 900 can comprise generating, by the system (e.g., generating component 214), based on the first dynamic elements, a prompt template (e.g., prompt template 260) corresponding to the specified context subject or the specified client entity and comprising second dynamic elements that define second context information (e.g., second context information 326) different from the first context information.

At 914, the non-limiting method 900 can comprise adjusting, by the system (e.g., finalizing component 224), a portion of the prompt template based on user entity input (e.g., user entry data 288) for the prompt template.

At 916, the non-limiting method 900 can comprise, based on parameters (e.g., parameters 340) defining a first illustration (e.g., first illustration 341) of the reference document, generating, by the system (e.g., illustrating component 218), a second illustration (e.g., second illustration 343) defining the second context information and employing the parameters.

At 918, the non-limiting method 900 can comprise generating, by the system (e.g., finalizing component 224), a resultant document (e.g., resultant document 290) based on the prompt template and on the user entity input.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide a system, computer-implemented method and/or computer program product to facilitate a process to generate a prompt template 160, 260 based on a reference document 154, 254 and to generate a resultant document 290 based on the prompt template 160, 260. A exemplary system comprises a memory that stores and a processor that executes computer executable components stored in the memory, wherein the computer executable components comprise an identifying component 112, 212 that identifies a reference document 154, 254 corresponding to a specified context subject 132, 302 or a specified client entity 134, 304, the reference document 154, 254 comprising first dynamic elements 140, 310 that define first context information 136, 306, and a generating component 116, 216 that, based on the first dynamic elements 140, 310, generates a prompt template 160, 260 corresponding to the specified context subject 132, 302 or the specified client entity 134, 304 and comprising second dynamic elements 170, 320 that define second context information 176, 326 different from the first context information 136, 306. In one or more cases, the second dynamic elements 170, 320 comprise portions of the prompt template 160, 260 that are adjustable based on user entity data 288 for the prompt template 160, 260. In one or more cases, a finalizing component 224 generates a resultant document 290 based on the prompt template 160, 260 and on the user entity data 288.

Indeed, in view of the one or more embodiments described herein, a practical application of the one or more systems, computer-implemented methods and/or computer program products described herein can generally be a streamlined content generation, maintaining of prompt template and reference document uniformity, enhanced document professionalism, improved productivity, and/or reduced manual editing efforts.

In connection therewith, the one or more embodiments described herein can provide useful and/or practical applications of computers, thus providing enhanced (e.g., improved and/or optimized) prompt template generation that can minimize, expand upon, and/or maximize one or more dynamic elements and/or static elements of one or more reference documents, resulting in a new resultant document that differs from, and does not employ the exact structural skeleton of, the one or more reference documents. Overall, such computerized tools can constitute a concrete and tangible technical improvement in the fields of prompt template generation.

One or more embodiments described herein can be employed to perform two or more processes at least partially in parallel with one another for one or more different prompt templates and/or relative to one or more different reference documents.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program instruction and/or execution, as compared to existing systems and/or techniques unable to provide such usage and/or efficiencies. In one or more cases, such program instruction and/or execution can comprise generating a prompt template that can be styled and suited to a more narrow and particular purpose (corresponding to a desired context subject and/or client entity) while remaining consistent with client entity style and/or contextual subject matter style (e.g., style used for a particular contextual subject matter) corresponding to the selected one or more reference documents employed. Additionally, and/or alternatively, such program instruction and/or execution can comprise merging one or more writing styles from one or more reference documents into the prompt template and subsequent resultant document generated therefrom. For example, the one or more reference documents employed as writing style input to one or more analytical models can comprise the same one or more reference documents corresponding to a desired context subject and/or client entity and/or can be an alternative style reference document employed only for analysis of the writing style of that style reference document. Indeed, systems, computer-implemented methods and/or computer program products providing performance of these processes are of great utility in the fields of prompt template generation and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically or even partially automatically perform prompt template generation as the one or more embodiments described herein can provide these processes. Moreover, neither can the human mind nor a human with pen and paper conduct these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is provided.

A system, can comprise a memory that stores computer executable components, and a processor that executes the computer executable components stored in the memory, wherein the computer executable components comprise an identifying component that identifies a reference document corresponding to a specified context subject or a specified client entity, the reference document comprising first dynamic elements that define first context information, and a generating component that, based on the first dynamic elements, generates a prompt template corresponding to the specified context subject or the specified client entity and comprising second dynamic elements that define second context information different from the first context information.

In the system of the preceding paragraph, the second dynamic elements can comprise portions of the prompt template that are adjustable based on user entity input for the prompt template.

In the system of any preceding paragraph, the computer executable components can further comprise a finalizing component that generates a resultant document based on the prompt template and on the user entity input.

In the system of any preceding paragraph, the second dynamic elements can comprise hierarchically-executed prompts that define cascading layers of the second context information.

In the system of any preceding paragraph, the computer executable components further can comprise a preserving component that identifies a writing style based on the reference document or on a secondary reference document, wherein the generating component generates the second dynamic elements based on the writing style.

In the system of any preceding paragraph, the computer executable components further can comprise an illustrating component that, based on parameters defining a first illustration of the reference document, generates a second illustration defining the second context information and employing the parameters.

In the system of any preceding paragraph, the identifying component can employ a natural language processing model that identifies the first dynamic elements by employing original text of the reference document as input and the first context information as conditions for the natural language processing model.

In the system of any preceding paragraph, the identifying component can employ a long short-term memory transformer that identifies the first dynamic elements by extracting tokens from the reference document that define contextual and semantic differences between the reference document and a secondary compare document.

A computer-implemented method can comprise identifying, by a system operatively coupled to a processor, a reference document corresponding to a specified context subject or a specified client entity, the reference document comprising first dynamic elements that define first context information, and generating, by the system, based on the first dynamic elements, a prompt template corresponding to the specified context subject or the specified client entity and comprising second dynamic elements that define second context information different from the first context information.

In the computer-implemented method of the preceding paragraph, the second dynamic elements can comprise portions of the prompt template that are adjustable based on user entity input for the prompt template.

The computer-implemented method of any preceding paragraph can further comprise generating, by the system, a resultant document based on the prompt template and on the user entity input.

In the computer-implemented method of any preceding paragraph, the second dynamic elements can comprise hierarchically-executed prompts that define cascading layers of the second context information.

The computer-implemented method of any preceding paragraph can further comprise identifying, by the system, a writing style based on the reference document or on a secondary reference document, and generating, by the system, the second dynamic elements based on the writing style.

The computer-implemented method of any preceding paragraph can further comprise employing, by the system, a natural language processing model that identifies the first dynamic elements by employing original text of the reference document as input and the first context information as conditions for the natural language processing model.

The computer-implemented method of any preceding paragraph can further comprise employing, by the system, a long short-term memory transformer that identifies the first dynamic elements by extracting tokens from the reference document that define contextual and semantic differences between the reference document and a secondary compare document.

A computer program product facilitating a process to generate a resultant document based on a prompt template can comprise a computer readable storage medium having program instructions embodied therewith, the program instructions executable by a processor to cause the processor to identify, by the processor, a reference document corresponding to a specified context subject or a specified client entity, the reference document comprising first dynamic elements that define first context information, and generate, by the processor, based on the first dynamic elements, a prompt template corresponding to the specified context subject or the specified client entity and comprising second dynamic elements that define second context information different from the first context information.

In the computer program product of the preceding paragraph, the second dynamic elements can comprise portions of the prompt template that are adjustable based on user entity input for the prompt template.

In the computer program product of any preceding paragraph, the program instructions can be further executable by the processor to cause the processor to generate, by the processor, the resultant document based on the prompt template and on the user entity input.

In the computer program product of any preceding paragraph, the second dynamic elements can comprise hierarchically-executed prompts that define cascading layers of the second context information.

In the computer program product of any preceding paragraph, the program instructions can be further executable by the processor to cause the processor to identify, by the processor, a writing style based on the reference document or on a secondary reference document, and generate, by the processor, the second dynamic elements based on the writing style.

### Computing Environment Description

Turning next to FIG. 11, a detailed description is provided of additional context for the one or more embodiments described herein at FIGS. 1-10.

FIG. 11 and the following discussion are intended to provide a brief, general description of a suitable computing environment 1100 in which one or more embodiments described herein at FIGS. 1-10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a target system by the bidirectional charging determination code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, one or more instructions for performing the inventive methods may be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor may be a thermometer, and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine that collects and stores helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate via WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an identifying component that identifies a reference document corresponding to a specified context subject or a specified client entity, the reference document comprising first dynamic elements that define first context information; and
a generating component that, based on the first dynamic elements, generates a prompt template corresponding to the specified context subject or the specified client entity and comprising second dynamic elements that define second context information different from the first context information.

2. The system of claim 1, wherein the second dynamic elements comprise portions of the prompt template that are adjustable based on user entity input for the prompt template.

3. The system of claim 2, wherein the computer executable components further comprise:
a finalizing component that generates a resultant document based on the prompt template and on the user entity input.

4. The system of claim 1, wherein the second dynamic elements comprise hierarchically-executed prompts that define cascading layers of the second context information.

5. The system of claim 1, wherein the computer executable components further comprise:
a preserving component that identifies a writing style based on the reference document or on a secondary reference document,
wherein the generating component generates the second dynamic elements based on the writing style.

6. The system of claim 1, wherein the computer executable components further comprise:
an illustrating component that, based on parameters defining a first illustration of the reference document, generates a second illustration defining the second context information and employing the parameters.

7. The system of claim 1, wherein the identifying component employs a natural language processing model that identifies the first dynamic elements by employing original text of the reference document as input and the first context information as conditions for the natural language processing model.

8. The system of claim 1, wherein the identifying component employs a long short-term memory transformer that identifies the first dynamic elements by extracting tokens from the reference document that define contextual and semantic differences between the reference document and a secondary compare document.

9. A computer-implemented method, comprising:
identifying, by a system operatively coupled to a processor, a reference document corresponding to a specified context subject or a specified client entity, the reference document comprising first dynamic elements that define first context information; and
generating, by the system, based on the first dynamic elements, a prompt template corresponding to the specified context subject or the specified client entity and comprising second dynamic elements that define second context information different from the first context information.

10. The computer-implemented method of claim 9, wherein the second dynamic elements comprise portions of the prompt template that are adjustable based on user entity input for the prompt template.

11. The computer-implemented method of claim 10, further comprising:
generating, by the system, a resultant document based on the prompt template and on the user entity input.

12. The computer-implemented method of claim 9, wherein the second dynamic elements comprise hierarchically-executed prompts that define cascading layers of the second context information.

13. The computer-implemented method of claim 9, further comprising:
identifying, by the system, a writing style based on the reference document or on a secondary reference document; and
generating, by the system, the second dynamic elements based on the writing style.

14. The computer-implemented method of claim 9, further comprising:
employing, by the system, a natural language processing model that identifies the first dynamic elements by employing original text of the reference document as input and the first context information as conditions for the natural language processing model.

15. The computer-implemented method of claim 9, further comprising:
employing, by the system, a long short-term memory transformer that identifies the first dynamic elements by extracting tokens from the reference document that define contextual and semantic differences between the reference document and a secondary compare document.

16. A computer program product facilitating a process to generate a resultant document based on a prompt template, the computer program product comprising a computer readable storage medium having program instructions embodied therewith, the program instructions executable by a processor to cause the processor to:
identify, by the processor, a reference document corresponding to a specified context subject or a specified client entity, the reference document comprising first dynamic elements that define first context information; and
generate, by the processor, based on the first dynamic elements, a prompt template corresponding to the specified context subject or the specified client entity and comprising second dynamic elements that define second context information different from the first context information.

17. The computer program product of claim 16, wherein the second dynamic elements comprise portions of the prompt template that are adjustable based on user entity input for the prompt template.

18. The computer program product of claim 17, wherein the program instructions are further executable by the processor to cause the processor to:
generate, by the processor, the resultant document based on the prompt template and on the user entity input.

19. The computer program product of claim 16, wherein the second dynamic elements comprise hierarchically-executed prompts that define cascading layers of the second context information.

20. The computer program product of claim 16, wherein the program instructions are further executable by the processor to cause the processor to:
identify, by the processor, a writing style based on the reference document or on a secondary reference document; and
generate, by the processor, the second dynamic elements based on the writing style.
